(19) United States
(12) Patent Application Publication
(10) Pub. No.: US 2012/0291427 A1
(43) Pub. Date: Nov. 22, 2012

(54) ATTACHMENT CONTROL APPARATUS FOR HYDRAULIC EXCAVATOR

(75) Inventors: Hiroyuki Azuma, Ushiku-shi (JP); Tsuyoshi Nakamura, Tsuchiura-shi (JP); Yasuo Okano, Tsuchiura-shi (JP); Kouji Ishikawa, Kasumigaura-shi (JP)

(73) Assignee: HITACHI CONSTRUCTION MACHINERY CO., LTD., Bunkyo-ku, Tokyo (JP)

(21) Appl. No.: 13/497,751

(22) PCT Filed: Nov. 29, 2010
(86) PCT No.: PCT/JP2010/071293

§ 371 Date: Mar. 22, 2012

(30) Foreign Application Priority Data
Feb. 10, 2010 (JP) 2010-028076

(51) Int. Cl. E02F 9/22; F15B 20/00

(52) U.S. Cl. 60/420

(57) ABSTRACT

In an attachment control apparatus for a hydraulic excavator having a hydraulic circuit that includes a hydraulic pump, a plurality of actuators having a breaker which is an attachment actuator, and a plurality of flow control valves having an attachment flow control valve that is switched by operation pilot pressure from a control pedal device to supply delivery fluid of the hydraulic pump to the attachment actuator, if the control pedal device is operated in a state where an attachment mode is not selected by an attachment selection device, the movement of the attachment actuator is limited. Thus, failure and reduced life of the attachment and other hydraulic devices can be prevented in the event that an operator has forgotten to switch from a normal mode to an attachment mode and has operated the attachment.

### TECHNICAL FIELD

The present invention relates generally to an attachment control apparatus for a hydraulic excavator. The invention particularly relates to an attachment control apparatus for a hydraulic excavator having a hydraulic circuit for an attachment mounted on a front work device of the hydraulic excavator.

### BACKGROUND ART

A construction machine or a hydraulic excavator excavates and performs other works using a versatile bucket mounted on the leading end of a front work device. In addition, a construction machine or a hydraulic excavator excavates and performs various works with the use of an attachment such as a breaker, a crusher or the like in place of using the versatile bucket.

For attachments mounted on the front work device, specifications covering pressure, flow rate, etc. of hydraulic fluid are defined according to the type of each attachment. It is necessary, therefore, to change the setting of a hydraulic circuit or the like depending on the type of an attachment mounted on the front work device.

Conventional technologies for changing the setting (the mode) according to the type of the attachment mounted on the front work device are disclosed in, for example, Patent Documents 1 and 2.

The conventional technology described in Patent Document 1 is as below. A connector is attached to an attachment such as a breaker or the like. This connector sets bit patterns specific to respective attachments according the presence or absence of grounding of a plurality of cables. The connector is connected via a harness to a control unit installed on a construction machine main body side. Upon detection of the operation of the attachment, a hydraulic pump is controlled by use of a control condition set value corresponding to the bit pattern specific to the attachment, among the pump control condition set values stored previously in the control unit. In this way, a pump control condition suitable for a particular attachment can be set from among the pump control conditions required for a plurality of the attachments.

The conventional technology described in Patent Document 2 is as below. If a low-capacity type actuator is mounted that does not need the maximum amount of fluid from a hydraulic pump, an operator switches a mode-changeover switch to a low-capacity type actuator use mode. Concurrently, the operator uses an accelerator potentiometer as a maximum delivery rate setting means to set the upper limit of hydraulic fluid delivery rate. The operator then selects minimum delivery rate from among the following: the hydraulic fluid delivery rate set by the maximum delivery rate setting means; a hydraulic fluid delivery rate positive-controlled in response to the operation amount of an operating pedal; and a hydraulic fluid delivery rate resulting from P-Q control in which the maximum torque of the hydraulic pump is set so as not to provide an excessive load to thereby limit the pump delivery rate. Thus, the flow rate of the hydraulic fluid delivered from the hydraulic pump is tilting-controlled such that hydraulic fluid is delivered at the selected delivery rate.

### PRIOR ART REFERENCES

### Patent Documents

Patent document 1: JP-9-105154-A
Patent document 2: Japanese Patent No. 3609923

### SUMMARY OF THE INVENTION

### Problem to be Solved by the Invention

However, the above-mentioned technologies do not consider the problem encountered when the operator forgets to switch from the normal mode to the attachment mode. The attachment may be operated still in the normal mode where the setting corresponding to the type of the attachment is not done. In such a case, the attachment is used with its specifications exceeded consequently, so that there is concern about the failure and reduced life of the attachment and of the other hydraulic devices. In addition, foreign matter such as dust or the like gets mixed in with return oil in some cases. An attachment such as a breaker or the like in which it is desired to directly return a return oil to a tank not via a control valve may be used still in the normal mode where the return oil should be returned to the tank via the control valve. In such a case, spool stick or the like due to dust or the like may possibly occur. As with the case where the attachment has been used with its specifications exceeded, there is concern about the occurrence of the failure and reduced life of the attachment and of the other hydraulic devices.

The present invention has been made in view of the above and aims to provide an attachment control apparatus for a hydraulic excavator that can prevent the failure and reduced life of an attachment and of other hydraulic devices in the event that an operator has forgotten to switch from a normal mode to an attachment mode and has operated the attachment.

### Means for Solving the Problem

(1) To achieve the above object, in the present invention, there is provided an attachment control apparatus for a hydraulic excavator having a hydraulic circuit that includes at least one hydraulic pump, a plurality of actuators having an attachment actuator, and a plurality of flow control valves having an attachment flow control valve that is switched by operation pilot pressure from attachment operating means to supply delivery fluid of the hydraulic pump to the attachment actuator. The attachment control apparatus includes: mode switching means for selecting either a non-attachment mode or an attachment mode and, upon selection of the attachment mode, switching a state of the hydraulic circuit to a state suitable for operating the attachment actuator; and movement limiting means for limiting the movement of the attachment actuator when the attachment operating means is operated in a state where the attachment mode is not selected by the mode switching means.

As described above, if the attachment operating means is operated in the state where the attachment mode is not selected, the movement of the attachment actuator is limited. Because of this constitution, in the event that the operator has forgotten to switch from the non-attachment mode to the attachment mode and has operated the attachment, it is possible to allow the operator to recognize the forgetting of the switching between the modes, and to prompt the operator to switch the mode to the attachment mode. Thus, it is possible to prevent the failure and reduced life of the attachment and of the other hydraulic devices.

(2) In the above (1), the movement limiting means limits the flow rate of hydraulic fluid that is supplied to the attachment actuator, thereby limiting the movement of the attachment actuator.

With this, if the attachment operating means is operated in the state where the attachment mode is not selected, the amount of fluid to be supplied to the attachment actuator is limited. Therefore, in the event that the operator has forgotten to switch from the non-attachment mode to the attachment mode and has operated the attachment, it is possible to allow the operator to recognize the forgetting of the switching between the modes, and to prompt the operator to switch the mode to the attachment mode. In addition, it is possible to suppress the use of the attachment with its specifications exceeded. Thus, it is possible to prevent the failure and reduced life of the attachment and of the other hydraulic devices.

(3) In the above (2), the movement limiting means limits the delivery rate of the hydraulic pump, thereby limiting the flow rate of the hydraulic fluid that is supplied to the attachment actuator.

(4) In the above (2), the movement limiting means limits the flow rate of hydraulic fluid passing through the attachment flow control valve, thereby limiting the flow rate of the hydraulic fluid that is supplied to the attachment actuator.

### Effect of the Invention

The present invention can prevent the failure and reduced life of the attachment and of the other hydraulic devices in the event that the operator has forgotten to switch from the normal mode to the attachment mode and has operated the attachment.

### BRIEF DESCRIPTION OF THE DRAWINGS

FIG. 1 schematically illustrates the entire configuration of a hydraulic circuit system for a hydraulic excavator provided with an attachment control apparatus according to a first embodiment of the present invention.

FIG. 2 is a block diagram illustrating processing contents of a control unit according to the first embodiment of the present invention.

FIG. 3 illustrates the details of processing contents of a pump capacity control section according to the first embodiment of the present invention.

FIG. 4 illustrates the details of processing contents of a hydraulic line control section according to the first embodiment of the present invention.

FIG. 5 illustrates the external appearance of the hydraulic excavator to which the attachment control apparatus according to the first embodiment of the present invention is applied.

FIG. 6 schematically illustrates the entire configuration of a hydraulic circuit system for a hydraulic excavator provided with an attachment control apparatus according to a second embodiment of the present invention.

FIG. 7 is a block diagram illustrating processing contents of a control unit according to the second embodiment of the present invention.

FIG. 8 illustrates the details of processing contents of a pump capacity control section according to the second embodiment of the present invention.

FIG. 9 illustrates the details of processing contents of a pilot pressure control section according to the second embodiment of the present invention.

### MODE FOR CARRYING OUT THE INVENTION

Embodiments of the present invention will hereinafter be described with reference to the drawings.

### First Embodiment

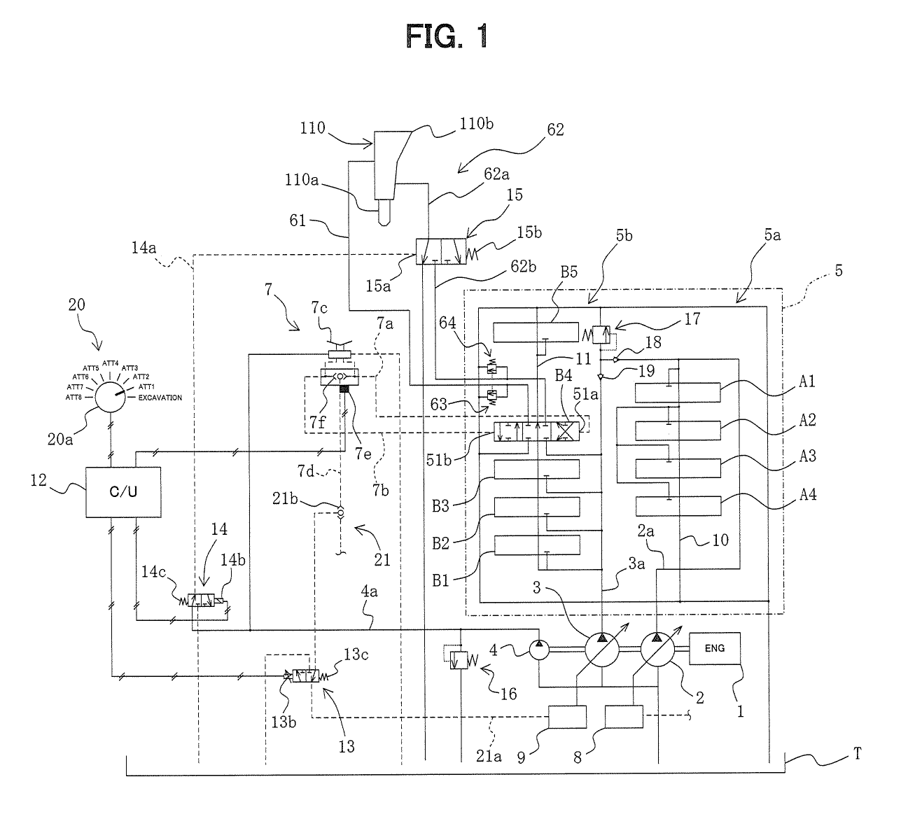

FIG. 1 schematically illustrates the entire configuration of a hydraulic circuit system for a hydraulic excavator provided with an attachment control apparatus according to a first embodiment of the present invention.

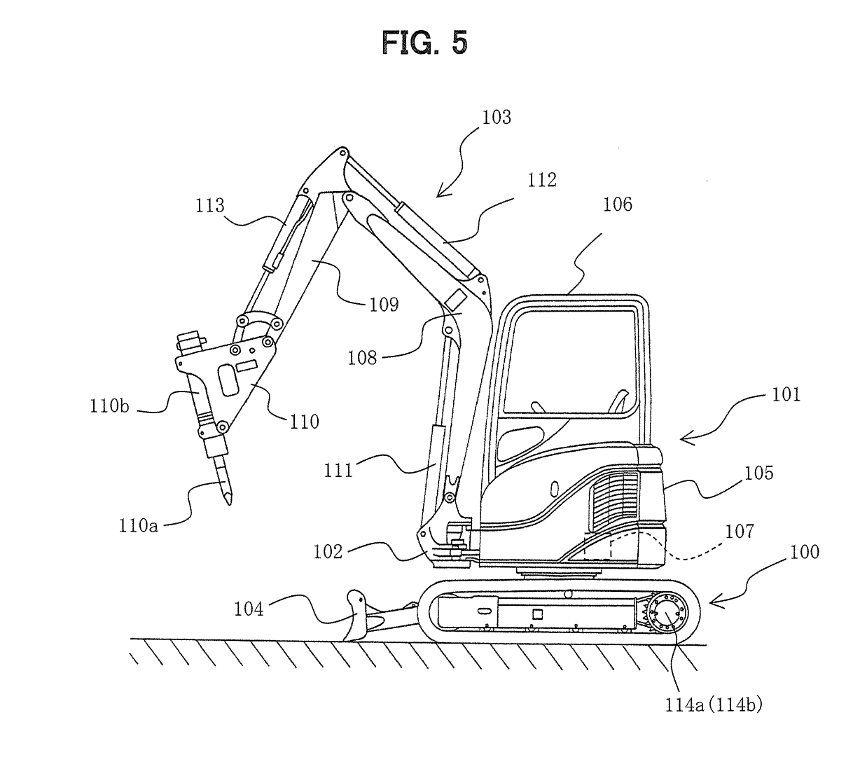

Referring to FIG. 1, the hydraulic circuit system for the hydraulic excavator includes a prime mover 1 such as an engine; two main pumps, i.e., variable displacement first and second hydraulic pumps 2 and 3 driven by the prime mover 1; a fixed displacement pilot pump 4 driven by the prime mover 1; a control valve unit 5 connected to the first and second hydraulic pumps 2, 3; a breaker 110 as an attachment connected to the control valve unit 5; a plurality of hydraulic actuators (see subsequent FIG. 5) including a boom cylinder 111, an arm cylinder 112, a bucket cylinder 113 and a swing motor 107 which are connected to the control valve unit 5 and not shown in the figure; a control pedal device 7 (attachment operating means) for operating the attachment (the breaker 110 in the embodiment); a plurality of operating units (not shown) including the operating units (not shown) for operating hydraulic actuators such as the boom cylinder 111, the arm cylinder 112, the bucket cylinder 113, the swing motor 107, traveling motors 114a, 114b, etc.; and pump capacity control systems 8, 9 for controlling the capacities (displacement volume or tilting of a swash plate) of the first and second hydraulic pumps 2, 3.

An attachment is mounted on a front work device 103 (see subsequent FIG. 5) in place of the bucket used for excavating, etc. and is used for various works. In the present embodiment, a description is given taking as an example the case where the breaker 110, one of attachments, is mounted on the front work device 103. The breaker 110, one of the attachments, is mounted on the leading end of the front work device 103 and used for performing work for crushing a massive object such as a large rock, a concrete mass or the like. The breaker 110 includes a hitting rod 110a composed of a steel rod having a point, or the like; and a breaker cylinder 110b used to drive the hitting rod 110a. The breaker 110 is designed such that hydraulic fluid is fed to a supply port (not shown) of the breaker cylinder 110b to allow the hitting rod 110a to reciprocate for hitting the massive object for fracture.

The control valve unit 5 has first and second valve groups 5a and 5b corresponding to the first and second hydraulic pumps 2 and 3, respectively. The first valve group 5a has a plurality of flow control valves A1 to A4 and the second valve group 5b has a plurality of flow control valves B1 to B5.

In the first valve group 5a, the flow control valves A1 to A4 are center bypass type flow control valves arranged on a center bypass line 10 connected to a delivery line 2a of the first hydraulic pump 2 in the order of the flow control valves A1 to A4 from the upstream side. In the second valve group 5b, the flow control valves B1 to B5 are center bypass type flow control valves arranged on a center bypass line 11 connected to a delivery line 3a of the second hydraulic pump 3 in the order of the flow control valves B1 to B5 from the upstream side. In the first and second valve groups 5a, 5b, the respective most downstream sides of the center bypass lines 10, 11 are connected to a tank T. When the flow control valves A1 to A4, B1 to B4 are each at a neutral position shown in the figure, the respective delivery lines 2a, 3a of the first and second hydraulic pumps 2, 3 communicate with the tank T via the corresponding center bypass lines 10, 11 so that the delivery pressure of each of the first and second hydraulic pumps 2, 3 lowers to a tank pressure.

The flow control valve B4 is used for driving the attachment. In the embodiment, the flow control valve B4 has two actuator ports, one of which is connected to a supply port (not sown) of the breaker 110, the attachment, via a first actuator line 61. The other is connected to a discharge port (not shown) of the breaker 110 via a second actuator line 62. The second actuator line 62 is composed of two portions, i.e., hydraulic lines 62a, 62b. The flow control valve B4 has first and second pressure-receiving portions 51a, 51b. If operation pilot pressure is led to the first pressure-receiving portion 51a, the flow control valve B4 is switched to a right position in the figure to supply the delivery fluid of the second hydraulic pump 3 to the attachment via the first actuator line 61. If the operation pilot pressure is led to the second pressure-receiving portion 51b, the flow control valve B4 is switched to a left position in the figure to supply the delivery fluid of the second hydraulic pump 3 to the attachment via the second actuator line 62. However, in the breaker 110, i.e., the attachment used in the embodiment, the supply port and the discharge port for hydraulic fluid are fixed. Therefore, the position of the flow control valve B4 is switched to only the right position in the figure where the delivery fluid of the second hydraulic pump 3 is supplied to the supply port of the breaker 110 via the first actuator line 61. Relief valves 63 and 64 are respectively connected to the first and second actuator lines 61 and 62 connected to the two actuator ports of the flow control valve B4. In this way, the pressure of the hydraulic fluid flowing in the first and second actuator lines 61, 62 is regulated to a given level or below.

Although illustration and detailed description are omitted, the flow control valves A1 to A4 of the first valve group 5a and the flow control valves B1 to B3, B5 of the second valve group 5b are used for driving the plurality of hydraulic actuators (not shown) including the boom cylinder 111, the arm cylinder 112, the bucket cylinder 113 and the swing motor 107 (see subsequent FIG. 5). Also these flow control valves have pressure-receiving portions similarly to the flow control valve B4 and are each operatively switched similarly thereto.

The control valve unit 5 is provided with a main relief valve 17. The relief valve 17 is connected to the respective delivery lines 2a and 3a of the first and second hydraulic pumps 2, 3 via non-return valves (check valves) 18 and 19, respectively. The relief valve 17 is adapted to regulate the delivery pressure of each of the first and second pumps 2, 3 to a given level or below. The check valves 18, 19 are connected in parallel to the input port side of the main relief valve 17. In addition, the check valves 18, 19 permit hydraulic fluid to flow from the first and second pumps 2, 3 toward the main relief valve 17 but inhibit it from flowing in the reverse direction. A pilot relief valve 16 is connected to a delivery line 4a of the pilot pump 4. The pilot relief valve 16 is adapted to maintain the delivery pressure of the pilot pump 4 at a constant level.

The pump capacity control system 8 is adapted to control the capacity (displacement volume or tilting of a swash plate) of the first hydraulic pump 2 which supplies hydraulic fluid to the actuators corresponding to the first valve group 5a. The pump capacity control system 8 controls the capacity of the first hydraulic pump 2 on the basis of operation signals (operation pilot pressures) or the like of operating units associated with the flow control valves A1 to A4 of the first valve group 5a.

The pump capacity control system 9 is adapted to control the capacity of the second hydraulic pump 3 which supplies hydraulic fluid to the actuators corresponding to the second valve group 5b that is a valve group including the flow control valve B4 limiting the flow rate of the hydraulic fluid supplied to the actuator. The pump capacity control system 9 controls the capacity of the second hydraulic pump 3 on the basis of pilot pressure selected by a shuttle valve group 21 to be described later and led via a pilot line 21a, among operation signals (operation pilot pressures) of operating units (not shown) associated with the flow control valves B1 to B5 of the second valve group 5b, such as the control pedal device 7 (to be described later) which is an operating unit associated with the flow control valve B4.

The control pedal device 7 (the attachment operating means) is of a hydraulic pilot type having a control pedal 7c. In addition, the control pedal device 7 outputs operation pilot pressure as an attachment operating signal in response to the operating direction and operation amount of the control pedal 7c. The operation pilot pressure outputted from the control pedal device 7 is led via pilot lines 7a and 7b to the corresponding pressure-receiving portions 51a and 51b, respectively, of the flow control valve B4 for driving the attachment. A shuttle valve 7f connected between the pilot lines 7a and 7b selects the higher of operation pilot pressures outputted to the pilot lines 7a, 7b, i.e., the pilot pressure corresponding to the operation amount of the control pedal 7c. Such pilot pressure is led to the shuttle valve group 21 to be described later via a pilot line 7d.

The shuttle valve group 21 is connected to the pilot line 7d from the control pedal device 7. In addition, the shuttle valve 21 is connected to each of pilot lines (not shown) adapted to lead operation pilot pressure to a corresponding one of the flow control valves B1 to B5 of the second valve group 5b from a corresponding one of operating units (not shown) for operating hydraulic actuators such as the boom cylinder 111, the arm cylinder 112, the bucket cylinder 113, the swing motor 107, the traveling motors 114a, 114b, etc.

The shuttle valve group 21 has a shuttle valve 21b and a plurality of shuttle valves not shown. The shuttle valves not shown are provided to connect together the pilot lines of the plurality of operating units not shown in a tournament manner to extract the maximum pressure of the pilot pressures in the pilot lines. In addition, the shuttle valve 21b is connected between the pilot line 7b and an output port of the final-stage shuttle valve associated with another operating unit not shown. In this way, the shuttle valve group 21 having the shuttle valve 21b as the final stage extracts and outputs the maximum pressure among the operation pilot pressures from the control pedal device 7 and the operation pilot pressures from the other operating units not shown. The output port of the final-stage shuttle valve 21b is connected to the pump capacity control system 9 of the second hydraulic pump 3 via the pilot line 21a. The capacity of the second hydraulic pump 3 is controlled based on the operating conditions of the control pedal device 7 and of the other operating units.

An attachment control apparatus according to the present embodiment is installed in such a hydraulic circuit system for a hydraulic excavator. The attachment control apparatus includes an attachment selection device 20 (mode switching means), an operation amount sensor 7e installed in the control pedal device 7, a solenoid proportional valve 13, a solenoid directional control valve 14, a directional control valve 15 and a control unit 12.

The attachment selection device 20 is used by an operator to select an operation mode in accordance with the bucket or the type of the attachment which are mounted on the front work device 103 of the hydraulic excavator. The attachment selection device 20 has a rotating dial 20a for selecting the operation mode. The rotating dial 20a is designed to be capable of not only rotating operation but also depression. The operation mode is selected by the combination of the rotating operation with depressing operation of the rotating dial 20a. For example, if the operation mode is to be switched to ATT1, the position of operation mode name ATT1 is selected with the rotating dial 20a as shown in FIG. 1 and the rotating dial 20a is depressed. The selection result of the attachment selection device 20 is sent to the control unit 12.

The operation amount sensor 7e is adapted to detect an operation amount of the control pedal 7c of the control pedal device 7 used to operate the attachment and sends the detection result (the operation amount of the control pedal 7c) to the control unit 12.

The solenoid proportional valve 13 is installed on the pilot line 21a connecting the final-stage shuttle valve 21b of the shuttle valve group 21 with the pump capacity control system 9 of the second hydraulic pump 3. The solenoid proportional valve 13 regulates the pilot pressure led from the shuttle valve group 21 to the pump capacity control system 9 in accordance with a control current flowing from the control unit 12 to a solenoid 13b. When the current flowing from the controller 12 to the solenoid 13b is equal to 0, the solenoid proportional valve 13 is switched to the right position shown in the figure by the force of a spring 13c. As the current flowing to the solenoid 13b is increased, the solenoid proportional valve 13 is gradually switched to the left position shown in the figure to reduce the pilot pressure led to the pump capacity control system 9.

The solenoid directional control valve 14 is connected to a pilot line 14a that is connected to a pressure-receiving portion 15a of the directional control valve 15. The solenoid directional control valve 14 is ON/OFF controlled in accordance with the current flowing from the control unit 12 to a solenoid 14b. When the current flowing from the controller 12 to the solenoid 14b is equal to 0, the solenoid directional control valve 14 is switched to the left position (the OFF-position) shown in the figure by the force of a spring 14c. The pilot line 14a communicates with the delivery line 4a of the pilot pump 4. The pilot pressure of the pilot line 4a is supplied to the pressure-receiving portion 15a of the directional control valve 15 to be described later. When an excitation current is allowed to flow from the controller 12 to the solenoid 14b, the solenoid directional control valve 14 is switched to the right position (the ON-position) shown in the figure. The pilot line 14a communicates with the tank T so that the pressure-receiving portion 15a of the directional control valve 15 is at a tank pressure.

The directional control valve 15 is installed between the hydraulic lines 62a and 62b of the second actuator line 62 that is connected to the discharge port of the breaker 110 which is an attachment. The directional control valve 15 is ON/OFF controlled in accordance with the pilot pressure led to the pressure-receiving portion 15a via the pilot line 14a. When the pilot pressure to be led to the pressure-receiving portion 15a is at a tank pressure, the directional control valve 15 is switched by the force of a spring 15b to the right position shown in the figure at which the hydraulic line 62a is communicated with the hydraulic line 62b. When the pilot pressure to be led to the pressure-receiving portion 15a is at the delivery pressure of the pilot pump 4, the directional control valve 15 is switched to the left position shown in the figure at which the hydraulic line 62a is communicated with the tank T. That is, when the directional control valve 15 is at the left position shown in the figure, the discharge port of the breaker 110 which is an attachment is connected via the hydraulic line 62a to the tank T, so that the return oil from the breaker 110 is directly led to the tank T.

The control unit 12 controls the attachment control apparatus according to the present embodiment. The control unit 12 sends current to the solenoid proportional valve 13 and the solenoid directional control valve 14 on the basis of the input from the attachment selection device 20 and the operation amount sensor 7e.

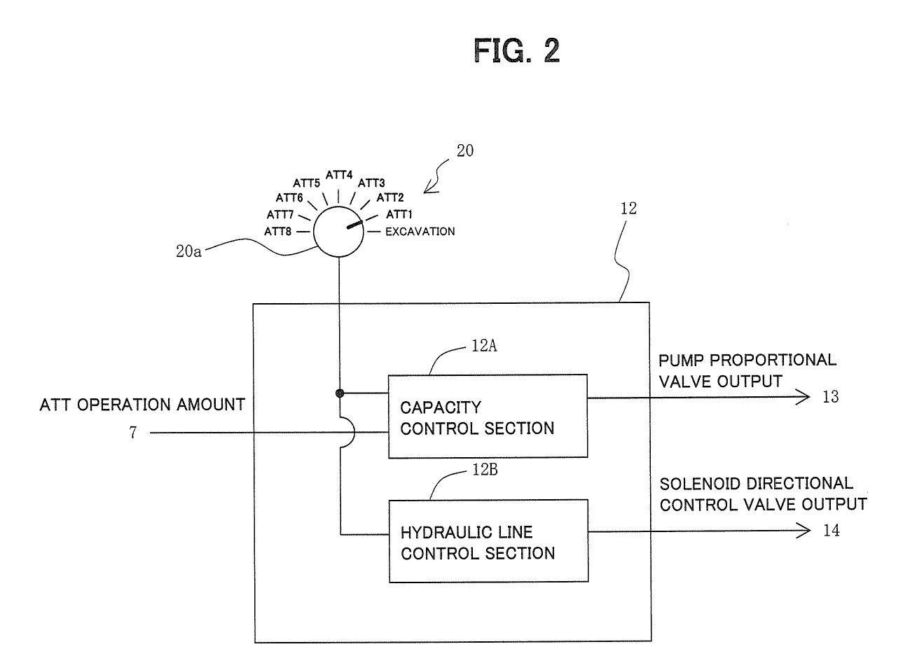

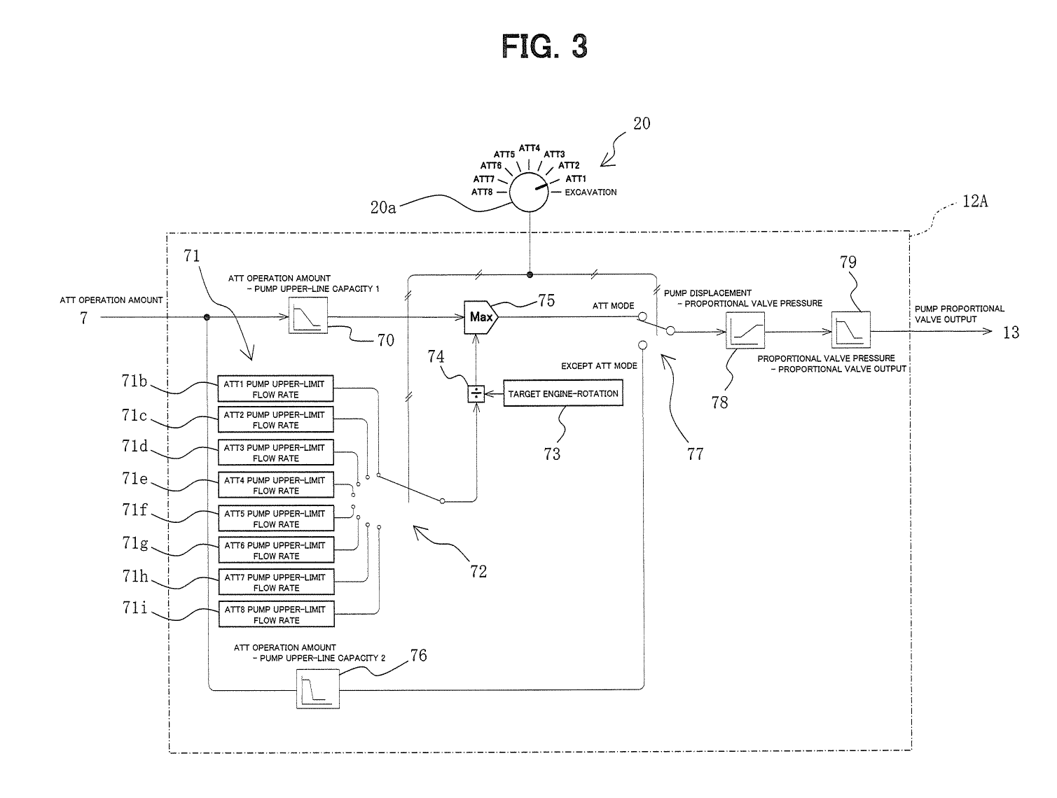

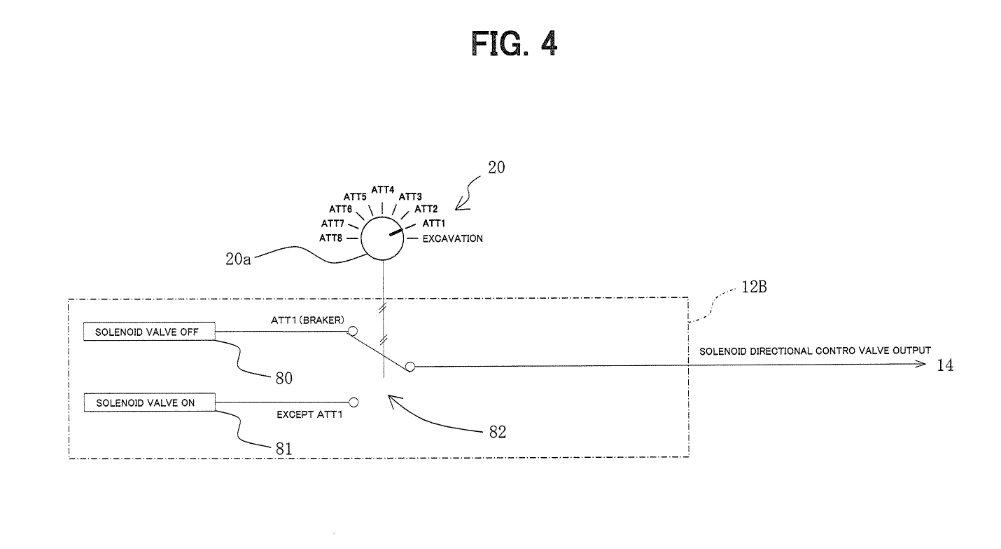

FIG. 2 is a block diagram illustrating processing contents of the control unit according to the present embodiment. FIG. 3 illustrates the details of processing contents of a pump capacity control section. FIG. 4 illustrates the details of processing contents of a hydraulic line control section. Incidentally, FIGS. 2 to 4 concurrently illustrate the attachment selection device 20 for explanation.

Referring to FIG. 2, the control unit 12 includes a capacity control section 12A (see FIG. 3) and a hydraulic line control section 12B (see FIG. 4). The capacity control section 12A controls the capacity of the second hydraulic pump 3 by controlling the solenoid proportional valve 13 on the basis of the selection result of the attachment selection device 20 and the detection result of the operation amount sensor 7e of the control pedal device 7. The hydraulic line control section 12B switches between the positions of the directional control valve 15 by controlling the solenoid directional control valve 14 on the basis of the selection result of the attachment selection device 20.

Referring to FIG. 3, the capacity control section 12A has a function of each of a pump upper-limit capacity first calculation section 70, a pump upper-limit flow setting section group 71, a pump upper-limit flow selection switch section 72, a target engine-speed setting section 73, a division section 74, a maximum value selection section 75, a pump upper-limit capacity second calculation section 76, an operation mode selection switch section 77, a proportional valve pressure calculation section 78, and a proportional valve output current calculation section 79.

The pump upper-limit capacity first calculation section 70 receives the detection result of an operation amount of the control pedal 7c from the operation amount sensor 7e of the control pedal device 7, i.e. the detection result of the attachment operation amount (the ATT operation amount). The first calculation section 70 then refers the detection result to a table stored in a memory and calculates a pump upper-limit capacity corresponding to the then ATT operation amount. In the table of the memory, the relationship between the ATT operation amount and the pump upper-limit capacity is established as below. When the ATT operation amount is small, the pump upper-limit capacity is large (e.g. the maximum delivery capacity of the second hydraulic pump 3). As the ATT operation amount is increased, the pump upper-limit capacity is gradually reduced. The pump upper-limit capacity is reduced to a level (for example, the delivery capacity of a minimal value capable of containing the whole of the setting values of pump upper-limit flow set in pump upper-limit flow setting sections 71b to 71i of the pump upper-limit flow setting section group 71 to be described later) where the delivery rate of the second hydraulic pump 3 is a basic flow rate. In other words, when the control pedal 7c of the control pedal device 7 (the attachment operating means) is not operated or the operation amount is small, the maximum delivery capacity is set as a pump upper-limit capacity so as not to limit the upper-limit flow of the second hydraulic pump 3. When the control pedal 7c is operated at a maximum, the maximum delivery capacity is set at the above-mentioned pump upper-limit capacity (the pump upper-limit capacity where the delivery rate of the second hydraulic pump 3 is a basic flow rate). With the exception of the above, the pump upper-limit capacity is set so as to have metering (a flow-rate change characteristic) in view of maneuverability.

The pump upper-limit flow setting section group 71 has the plurality of pump upper-limit flow setting sections 71b to 71i setting respective pump upper-limit flow rates suitable to perform excavating using a bucket or various works using various corresponding attachments. The pump upper-limit flow setting sections 71b to 71i set therein the respective pump upper-limit flows of the second hydraulic pump 3 suitable to perform various works by mounting various corresponding attachments (ATT) to the front work device 103. In the present embodiment, the breaker 110 is set as ATT1. The ATT1 upper-limit flow setting section 71b sets therein a pump upper-limit flow rate of the second hydraulic pump 3 suitable for the case where the breaker 110 is mounted to the front work device 103 for crushing work. This holds true for the other pump upper-limit flow setting sections 71c to 71i. Various attachments are set as ATT2 to ATT8. The pump upper-limit flow setting sections 71c to 71i set therein the pump upper-limit flows of the second hydraulic pump 3 each corresponding to the type of the attachment.

The pump upper-limit flow selection switch section 72 is switched to a position corresponding to an operation mode selected by the attachment selection device 20. In addition, the pump upper-limit flow selection switch section 72 outputs, to the division section 74, a pump upper-limit flow rate corresponding to excavation work with a bucket selected by the attachment selection device 20 or to each attachment, among the pump upper-limit flow rates set by the pump upper-limit flow setting sections 71b to 71i of the pump upper-limit flow setting section group 71. FIG. 2 illustrates the case as below. The attachment selection device 20 selects ATT1 (the breaker) so that the pump upper-limit flow selection switch section 72 is switched to the upper-limit flow setting section 71b corresponding to ATT1. In this way, the pump upper-limit flow selection switch section 72 outputs, to the division section 74, the pump upper-limit flow rate set in the pump upper-limit flow setting section 71b, i.e., the pump upper-limit flow rate of the second hydraulic pump 3 suitable for the case where the breaker 110 is mounted as an attachment to the front work device 103 for performing crushing work.

The target engine-speed setting section 73 sets therein a target engine-speed preset by an engine speed control dial or the like not shown.

The division section 74 divides a pump upper-limit flow rate selected and set by the pump upper-limit flow selection switch section 72, by the target engine-speed set by the target engine-speed setting section 73. In addition, the division section 74 outputs the divided value to the maximum value selection section 75.

The maximum value selection section 75 selects the maximum value of the pump upper-limit capacity calculated by the pump upper-limit capacity first calculation section 70 and the calculation result of the division section 74, and outputs it to the operation mode selection switch section 77.

The pump upper-limit capacity second calculation section 76 receives the detection result of the operation amount (the ATT operation amount) of the control pedal 7c from the operation amount sensor 7e of the control pedal device 7. Then, the second calculation section 76 refers the detection result to a table stored in a memory and calculates the pump upper-limit capacity corresponding to the then ATT operation amount. In the table of the memory, the relationship between the ATT operation amount and the pump upper-limit capacity is established as below. If the ATT operation amount is equal to 0 (zero) or is so small as to be regarded as 0 (zero), the pump upper-limit capacity is large (e.g. the maximum delivery capacity of the second hydraulic pump 3). If the ATT operation amount is increased (i.e., if the control pedal 7c is operated), the pump upper-limit capacity is reduced at once to a level where the delivery rate of the second hydraulic pump 3 is a basic flow rate.

If the attachment selection device 20 selects the mode in which an attachment is used (attachment mode: ATT1 to ATT8), the operation mode selection switch section 77 is switched to an attachment mode (ATT mode) side. In addition, the operation mode selection switch section 77 selects the pump capacity calculated by the maximum value selection section 75 and outputs it to the proportional valve pressure calculation section 78. If the attachment selection device 20 selects the mode in which excavation is performed by use of the bucket (non-attachment mode: excavation), the operation mode selection switch section 77 is switched to the side except the ATT mode. In addition, the operation mode selection switch section 77 selects the pump capacity calculated by the pump upper-limit capacity second calculation section 76 and outputs it to the proportional valve pressure calculation section 78.

The proportional valve pressure calculation section 78 receives the pump capacity selected by the operation mode selection switch section 77 and refers it to a table stored in a memory. In addition, the proportional valve pressure calculation section 78 calculates proportional valve pressure corresponding to the then pump capacity. In the table of the memory, the relationship between the pump capacity and the proportional valve pressure is established such that as the pump capacity is increased, the proportional valve pressure is gradually increased.

The proportional valve output current calculation section 79 receives the proportional valve pressure calculated by the proportional valve pressure calculation section 78 and refers it to a table stored in a memory. In addition, the proportional valve output current calculation section 79 calculates a proportional valve output current corresponding to the then proportional valve pressure. In the table of the memory, the relationship between the proportional valve pressure and the proportional valve output current is established such that as the proportional valve pressure is increased, the proportional valve output current is gradually reduced. The proportional valve output current calculated by the proportional valve output current calculation section 79 is output to the solenoid 13b of the solenoid proportional valve 13.

Referring to FIG. 4, the hydraulic line control section 12B has a function of each of a solenoid valve OFF-setting section 80, a solenoid valve ON-setting section 81, and an attachment selection switch section 82.

The solenoid valve OFF-setting section 80 has a function of outputting a current (current 0 (zero)) adapted to OFF-control the solenoid valve 14. The solenoid valve ON-setting section 81 has a function of outputting a current adapted to ON-control the solenoid valve 14, i.e., to energize the solenoid 14b of the solenoid valve 14 to switch the solenoid valve 14 to an ON-position.

If the attachment selection device 20 selects the mode (ATT1) in which the breaker 110 is used as an attachment, the attachment selection switch section 82 is switched to a solenoid valve OFF-setting section 80 side. In addition, the attachment selection switch section 82 outputs a current adapted to OFF-control the solenoid valve 14 (to switch it to the OFF-position), as the output of the hydraulic line control section 12B. If the attachment selection device 20 selects the mode (excavation, or any one of ATT2 to ATT8) except ATT1, the attachment selection switch section 82 is switched to a solenoid valve ON-setting section 81 side. In addition, the attachment selection switch section 82 outputs a current adapted to ON-control the solenoid valve 14 (to switch it to the ON-position), as the output of the hydraulic line control section 12B.

FIG. 5 illustrates the external appearance of the hydraulic excavator to which the attachment control apparatus according to the embodiment is applied. In addition, FIG. 5 illustrates the case where the breaker 110, one of attachments, is mounted.

Referring to FIG. 5, the hydraulic excavator includes a lower travel structure 100; an upper swing structure 101 mounted swingably on the upper portion of the lower travel structure 100; the front work device 103 coupled to the leading end portion of the upper swing structure 101 via a swing post 102 so as to be swingable vertically and horizontally; and an earth removal blade 104 installed vertically movably on the front side of the lower travel structure 100. An engine room 105 and a cabin 106 are installed on the upper swing structure 101. The swing motor 107 is installed on the upper swing structure 101. Thereby, the upper swing structure 101 is swingably driven by the rotation of the swing motor 107. The front work device 103 includes a boom 108 connected to the swing post 102 vertically swingably; an arm 109 connected to the leading end of the boom 108 vertically swingably; and the breaker 110 as an attachment connected to the leading end of the arm 109 so as to be swingable in the back and forth direction. The boom 108, the arm 109 and the breaker 110 are swingably driven by the boom hydraulic cylinder 111, the arm hydraulic cylinder 112 and a bucket hydraulic cylinder 113, respectively. The lower travel structure 100 is provided with left and right traveling motors 114a, 114b (only one is shown) and is driven by the rotation of the traveling motors 114a, 114b.

Incidentally, FIG. 1 omits the illustrations of actuators other than that of the breaker 110 (the attachment) shown in FIG. 3, namely, the actuators such as the traveling motors 114a, 114b and the like, and flow control valves corresponding thereto.

The control pedal device 7 shown in FIG. 1 is disposed inside the cabin 106. The engine 1, the first and second hydraulic pumps 2, 3 and the pilot pump 4 are disposed inside the engine room 105. The hydraulic devices such as the control valve unit 5 and the like are disposed in position on the upper swing structure 101.

A description is given of the operation in the embodiment configured as described above.

### (1) At the Time of Selecting the Non-Attachment Mode

If the attachment selection device 20 selects the excavation mode (the non-attachment mode), the pump upper-limit flow selection switch section 72 is switched to one (e.g. the ATT1 pump upper-limit flow setting section 71b) of the pump upper-limit flow setting section group 71. In addition, the operation mode selection switch section 77 is switched to the side except the ATT mode. The proportional valve pressure calculation section 78 calculates proportional valve pressure by use of the pump upper-limit capacity calculated by the pump upper-limit capacity second calculation section 76. The pump proportional valve output calculated by the proportional valve output current calculation section 79 by use of the proportional valve pressure becomes the output of the control unit 12. Additionally, the attachment selection switch section 82 is switched to the solenoid valve ON-setting section 81 side. The solenoid directional control valve output adapted to ON-control the solenoid directional control valve 14 becomes the output of the control unit 12. If the solenoid directional control valve 14 is ON-controlled, the pilot line 14a is at a tank pressure. The directional control valve 15 is switched to the right position shown in the figure, so that the hydraulic lines 62a, 62b of the second actuator line 62 are allowed to communicate with each other.

(1-1) In the Case where the Operating Unit Corresponding to the Front Work Device 103 is Operated

If the operating units (not shown) of the actuators corresponding to the flow control valves B1 to B5 of the second valve group 5b are operated, the maximum pressure among their operation signals (the operation pilot pressures) is extracted by the shuttle valve group 21 and led to the capacity control system 9. The capacity control system 9 controls the capacity of the second hydraulic pump 3 on the basis of such a pilot pressure. In other words, the capacity of the second hydraulic pump 3 is controlled so that the amount of fluid necessary to be supplied to the corresponding actuators via the flow control valves B1 to B5 of the second valve group 5b is delivered. In this way, the bucket is mounded on the front work device 103 and excavating can be done.

(1-2) In the Case where the Control Pedal Device 7 Corresponding to the Attachment is Operated

If the control pedal 7c of the control pedal device 7 is operated, its operation pilot pressure is led via the pilot line 7d to the shuttle valve 21b of the shuttle valve group 21. The maximum pressure among the operation pilot pressures including the operation signals from the other operating units is extracted by the shuttle valve group 21. In this case, the operation pilot pressure led from the shuttle valve group 21 to the capacity control system 9 is limited by the solenoid proportional valve 13 in accordance with the operation amount of the control pedal 7c. In other words, the capacity of the second hydraulic pump 3 is controlled so that the amount of the hydraulic fluid fed to the corresponding actuators via the flow control valves B1 to B5 of the second valve group 5b is limited. Therefore, even if the attachment (the breaker 110 in the embodiment) is mounted to the front work device 103 and work is intended to be done, the delivery rate of the second hydraulic pump 3 is not increased in accordance with the operation of the control pedal 7c of the control pedal device 7. Thus, the hydraulic fluid at a flow rate necessary for the attachment is not supplied to thereby significantly lower the working speed, so that the work using the attachment cannot be done.

(1-3) In the Case where the Operating Unit Corresponding to the Front Work Device 103 and the Control Pedal Device 7 Corresponding to the Attachment are Concurrently Operated

The operating units (not shown) of the actuators corresponding to the flow control valves B1 to B5 of the second valve group 5b and the control pedal 7c of the control pedal device 7 may concurrently be operated. In such a case, as described in above-mentioned (1-2), the operation pilot pressure led from the shuttle valve group 21 to the capacity control system 9 is limited by the solenoid proportional valve 13 in accordance with the operation amount of the control pedal 7c. In other words, the capacity of the second hydraulic pump 3 is controlled, so that the amount of the hydraulic fluid supplied to the corresponding actuators via the flow control valves B1 to B5 of the second valve group 5b is limited. Therefore, even if the attachment (the breaker 110 in the embodiment) is mounted on the front work device 103 and work is intended to be done, the delivery rate of the second hydraulic pump 3 is not increased in accordance with the operation of the control pedal 7c of the control pedal device 7 and with the operation of the operating unit corresponding to the front work device 103. Thus, hydraulic fluid at a flow rate necessary for the actuators of the attachment and of the front work device 103 is not supplied to thereby significantly lower the working speed, so that the work cannot be done.

### (2) At the Time of Selecting the Attachment Mode

If the attachment selection device 20 selects the attachment mode (e.g. the ATT1 mode in which the breaker 110 is used as the attachment), the pump upper-limit flow selection switch section 72 is switched to the ATT1 pump upper-limit flow setting section 71b. In addition, the operation mode selection switch portion 77 is switched to the ATT mode side. The proportional valve pressure calculation section 78 calculates proportional valve pressure by use of the pump upper-limit capacity selected by the maximum value selection section 75. The pump proportional valve output calculated by the proportional valve output current calculation section 79 using the proportional valve pressure becomes the output of the control unit 12. Additionally, the attachment selection switch section 82 is switched to the solenoid valve OFF-setting section 80 side, so that the solenoid directional control valve output adapted to OFF-control the solenoid directional control valve 14 becomes the output of the control unit 12. If the solenoid directional control valve 14 is OFF-controlled, the pilot line 14a is at a delivery pressure of the pilot pump 4. In addition, the directional control valve 15 is switched to the left position shown in the figure so that the hydraulic line 62a of the second actuator line 62 communicates with the tank T.

(2-1) In the Case where the Operating Unit Corresponding to the Front Work Device 103 is Operated

If the operating units (not shown) of the actuators corresponding to the flow control valves B1 to B5 of the second valve group 5b are operated, the maximum pressure among their operation signals (the operation pilot pressures) is extracted by the shuttle valve group 21 and led to the capacity control system 9. The capacity control system 9 controls the capacity of the second hydraulic pump 3 on the basis of such a pilot pressure. In other words, the capacity of the second hydraulic pump 3 is controlled so that the amount of fluid necessary to be supplied to the corresponding actuators via the flow control valves B1 to B5 of the second valve group 5b is delivered. In this way, the bucket is mounted on the front work device 103 and excavating can be done.

(2-2) In the Case where the Control Pedal Device 7 Corresponding to the Attachment is Operated

If the control pedal 7c of the control pedal device 7 is operated, its operation pilot pressure is led via the pilot line 7d to the shuttle valve 21b of the shuttle valve group 21. The maximum pressure among the operation pilot pressures including the operation signals from the other operating units is extracted by the shuttle valve group 21. In this case, the operation pilot pressure led from the shuttle valve group 21 to the capacity control system 9 is limited by the solenoid proportional valve 13 so as to provide the pump upper-limit flow rate corresponding to the attachment mode (ATT1) selected by the attachment selection device 20. In short, the pump upper-limit capacity of the capacity of the second hydraulic pump 3 is controlled to a value suitable for ATT1. Thus, the attachment (the breaker 110 in the present embodiment) can be mounted on the front work device 103 and the work can be done. In addition, the attachment is not used with its specifications exceeded so that it is possible to suppress the occurrence of the failure and reduced life of the attachment and of the other hydraulic devices.

(2-3) In the Case where the Operating Unit Corresponding to The Front Work Device 103 and the Control Pedal Device 7 Corresponding to the Attachment are Concurrently Operated

The operating unit (not shown) of the actuators corresponding to the flow control valves B1 to B5 of the second valve group 5b, and the control pedal 7c of the control pedal device 7 may concurrently be operated. In such a case, as described in the above (2-2), the operation pilot pressure led from the shuttle valve group 21 to the capacity control system 9 is limited by the solenoid proportional valve 13 so as to provide the pump upper-limit flow rate corresponding to the attachment mode (ATT1) selected by the attachment selection device 20. In short, the pump upper-limit capacity of the capacity of the second hydraulic pump 3 is controlled to a value suitable for ATT1. Thus, the attachment (the breaker 110 in the present embodiment) is mounted on the front work device 103 and the work can be performed while operating the front work device 103. In addition, the attachment is not used with its specifications exceeded so that it is possible to suppress the occurrence of the failure and reduced life of the attachment and of the other hydraulic devices.

In the embodiment configured as described above, if the pedal 7c of the control pedal device 7 is operated with the non-attachment mode selected in the attachment selection device 20, the flow rate of the hydraulic fluid to be supplied to the attachment is limited by limiting the delivery rate of the second hydraulic pump 3. In the case where the attachment is mounted on the front work device 103 and various works are to be done, the attachment may be operated still in the non-attachment mode where the setting corresponding to the type of the attachment is not made. In such a case, therefore, the working speed of the attachment is significantly lowered, so that the work cannot be done. Thus, it is possible to suppress the failure and reduced life of the attachment and of the other hydraulic devices in the event that an operator has forgotten to switch from the non-attachment mode to the attachment mode and has operated the attachment.

Additionally, it is possible to allow the operator to recognize that she or he has forgotten to switch from the non-attachment mode to the attachment mode. Prompting the operator to switch the operation mode to the attachment mode can further surely suppress the failure and reduced life of the attachment and of the other hydraulic devices.

### Second Embodiment

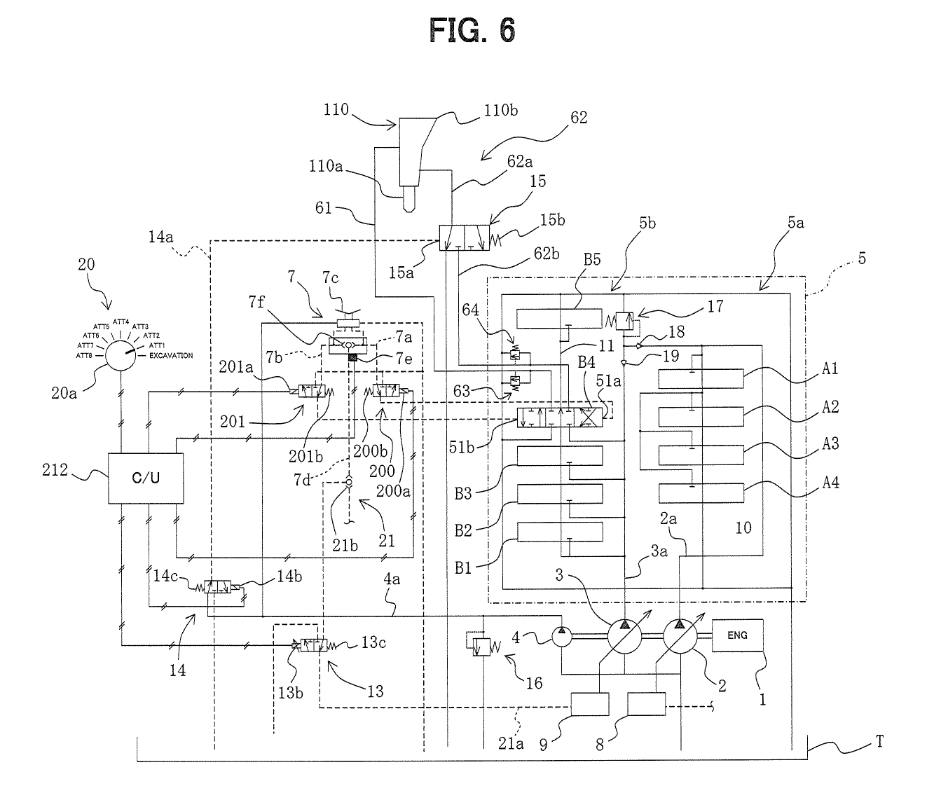

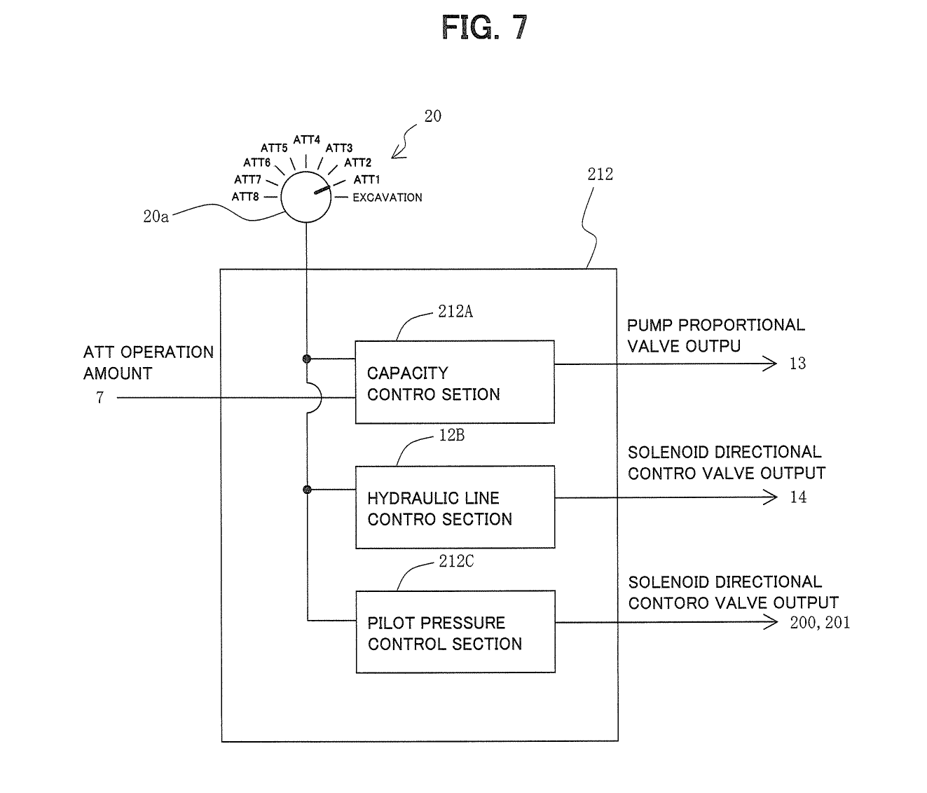

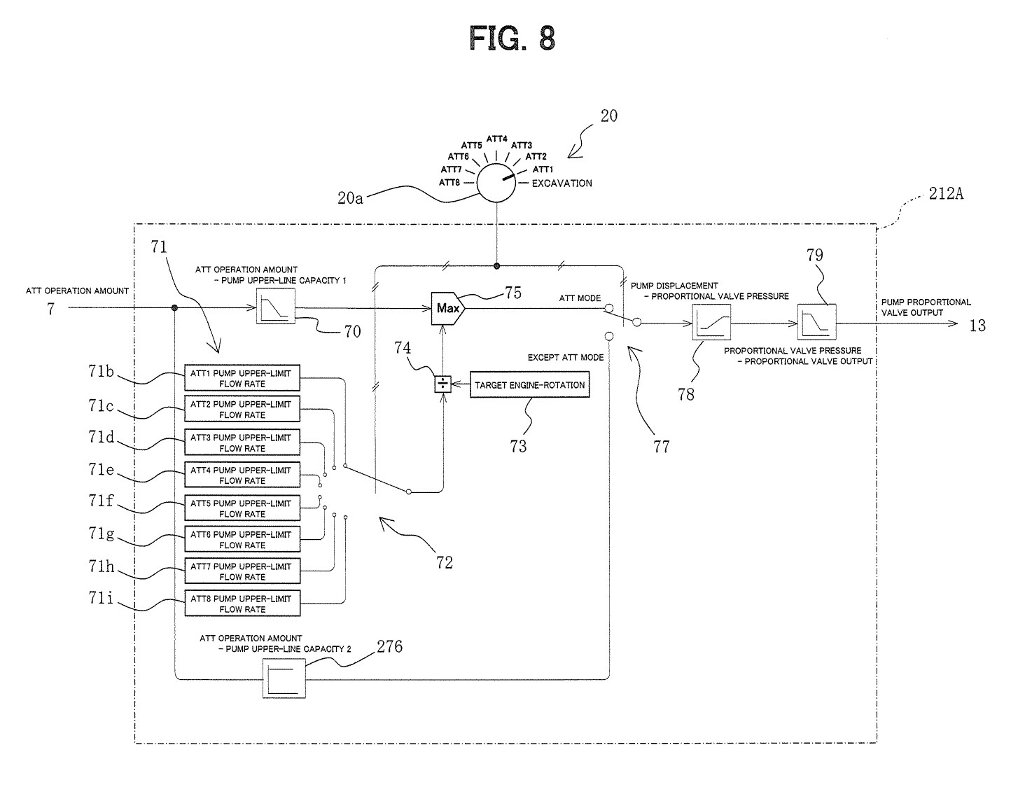

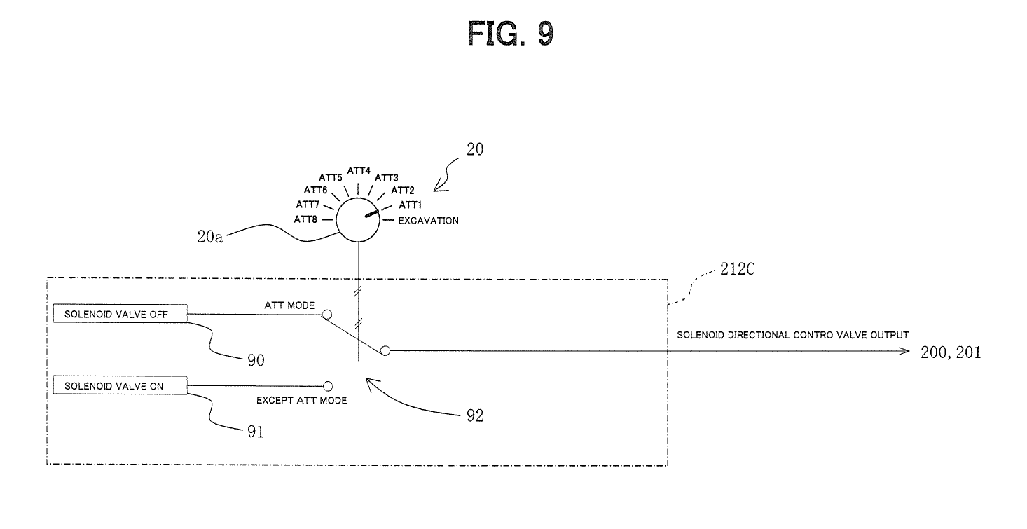

A second embodiment of the present invention is described with reference to FIGS. 6 to 9. FIG. 6 schematically illustrates the entire configuration of a hydraulic circuit system for a hydraulic excavator provided with an attachment control apparatus according to the present embodiment. FIG. 7 is a block diagram illustrating processing contents of a control unit according to the present embodiment. FIG. 8 illustrates the details of processing contents of a pump capacity control section. FIG. 9 illustrates the details of processing contents of a pilot pressure control section. Incidentally, FIGS. 7 to 9 concurrently illustrate the attachment selection device 20 for explanation. In the figures, the configurations equivalent to those shown in FIGS. 1 to 5 are denoted with like reference numerals and their explanations are omitted.

Referring to FIG. 6, similarly to the first embodiment, the hydraulic circuit system for the hydraulic excavator according to the present embodiment includes a prime mover 1 such as an engine; two main pumps, i.e., variable displacement first and second hydraulic pumps 2 and 3 driven by the prime mover 1; a fixed displacement pilot pump 4 driven by the prime mover 1; a control valve unit 5 connected to the first and second hydraulic pumps 2, 3; a breaker 110 as an attachment connected to the control valve unit 5; a plurality of hydraulic actuators including a boom cylinder 111, an arm cylinder 112, a bucket cylinder 113 and a swing motor 107 which are connected to the control valve unit 5 and not shown in the figure; a control pedal device 7 (attachment operating means) for operating the attachment (the breaker 110 in the embodiment); a plurality of operating units (not shown) including the operating units (not shown) for operating hydraulic actuators such as the boom cylinder 111, the arm cylinder 112, the bucket cylinder 113, the swing motor 107, traveling motors 114a, 114b, etc.; and pump capacity control systems 8, 9 for controlling the capacities (displacement volume or tilting of a swash plate) of the first and second hydraulic pumps 2, 3.

An attachment control apparatus according to the present embodiment is installed in the hydraulic circuit system for the hydraulic excavator as described above. The attachment control apparatus includes an attachment selection device 20 (mode switching means), an operation amount sensor 7e installed in the control pedal device 7, a solenoid proportional valve 13, a solenoid directional control valve 14, a directional control valve 15, solenoid proportional valves 200, 201, and a control unit 212.

The solenoid proportional valves 200 and 201 are installed on the pilot lines 7a and 7b, respectively, adapted to output operation pilot pressure from the control pedal device 7 to a flow control valve B4 for an actuator. In addition, the solenoid proportional valves 200 and 201 are controlled according to the current flowing from the control unit 212 to solenoids 200a and 201a, respectively. If current flowing in the solenoid 200a is equal to 0, that is, if the solenoid directional control valve 200 is not energized, the solenoid directional control valve 200 is switched by the force of a spring 200b to a position (OFF-position) to lead the operation pilot pressure from the control pedal device 7 to a pressure-receiving portion 51a of the flow control valve B4. If exciting current flows in the solenoid 200a, the solenoid directional control valve 200 is switched to a position (ON-position) to lead the tank pressure to the pressure-receiving portion 51a of the flow control valve B4. Similarly, if current flowing in the solenoid 201a is equal to 0, that is, if the solenoid directional control valve 201 is not energized, the solenoid directional control valve 201 is switched by the force of a spring 201b to a position (OFF-position) to lead the operation pilot pressure from the control pedal device 7 to a pressure-receiving portion 51b of the flow control valve B4. If exciting current flows in the solenoid 201a, the solenoid directional control valve 201 is switched to a position (ON-position) to lead tank pressure to the pressure-receiving portion 51b of the flow control valve B4.

The control unit 212 is adapted to control the attachment control apparatus according to the present embodiment. The control unit 212 outputs a drive current to the solenoid proportional valve 13 and the solenoid directional control valves 14, 200, 201 on the basis of the input from the attachment selection device 20 and the operation amount sensor 7e.

Referring to FIG. 7, the control unit (C/U) 212 includes a capacity control section 212A (see FIG. 8), a hydraulic line control section 12B and a pilot pressure control section 212C. The capacity control section 212A controls the capacity of the second hydraulic pump 3 by controlling the solenoid proportional valve 13 on the basis of the selection result of the attachment selection device 20 and the detection result of the operation amount sensor 7e of the control pedal device 7. The hydraulic line control section 12B switches between the positions of the directional control valve 15 by controlling the solenoid directional control valve 14 on the basis of the selection result of the attachment selection device 20. The pilot pressure control section 212C controls the solenoid directional control valves 200, 201 on the basis of the selection result of the attachment selection device 20.

Referring to FIG. 8, the capacity control section 212A includes a function of each of a pump upper-limit capacity first calculation section 70, a pump upper-limit flow setting section group 71, a pump upper-limit flow selection switch section 72, a target engine-speed setting section 73, a division section 74, a maximum value selection section 75, a pump upper-limit capacity second calculation section 276, an operation mode selection switch section 77, a proportional valve pressure calculation section 78, and a proportional valve output current calculation section 79.

The pump upper-limit capacity second calculation section 276 receives the detection result of the operation amount (the ATT operation amount) of the control pedal 7c from the operation amount sensor 7e of the control pedal device 7. In addition, the pump upper-limit capacity second calculation section 276 refers the detection result to a table stored in a memory and calculates the pump upper-limit capacity corresponding to the then ATT operation amount. On the table of the memory, the relationship between the ATT operation amount and the pump upper-limit capacity is established so that the pump upper-limit capacity may be constant (e.g. the maximum delivery capacity of the second hydraulic pump 3) regardless of the ATT operation amount.

Referring to FIG. 9, the pilot pressure control section 212C has a function of each of a solenoid valve OFF-setting section 90, a solenoid valve ON-setting section 91 and an attachment selection switch section 92.

The solenoid valve OFF-setting section 90 has a function of outputting a current (current 0 (zero)) adapted to switch the solenoid valves 200, 201 to an OFF-position. The solenoid valve ON-setting section 91 has a function of outputting a current adapted to switch the solenoid valves 200, 201 to an ON-position, i.e., a current adapted to excite the respective solenoids 200a, 201a of the solenoid valves 200, 201 and switch the valves 200, 201 to the ON-position.

If the attachment selection device 20 selects the mode in which the attachment is used (the attachment mode: ATT1 to ATT8), the attachment selection switch section 92 is switched to the ATT mode side (i.e., the solenoid valve OFF-setting section 90 side). The attachment selection switch section 92 outputs the current adapted to OFF-control (to switch to the OFF-position) the solenoid valves 200, 201 as an output of the attachment control section 212C. If the attachment selection device 20 selects the mode in which excavation is performed by use of the bucket (non-attachment mode: excavation), the attachment selection switch section 92 is switched to the side except the ATT mode (i.e., the solenoid valve ON-setting section 91 side). In addition, the attachment selection switch section 92 outputs the current adapted to ON-control (to switch to the ON-position) the solenoid valves 200, 201 as an output of the attachment control section 212C.

The other configurations are the same as those of the first embodiment.

A description is given of the operation of the embodiment configured as described above.

### (1) At the Time of Selecting the Non-Attachment Mode

If the attachment selection device 20 selects the excavation mode (the non-attachment mode), the pump upper-limit flow selection switch section 72 is switched to one (e.g. the ATT1 pump upper-limit flow rate 71b) of the pump upper-limit flow setting section group 71. In addition, the operation mode selection switch section 77 is switched to the side except the ATT mode. The proportional valve pressure calculation section 78 calculates proportional valve pressure by use of the pump upper-limit capacity calculated by the pump upper-limit capacity second calculation section 76. The pump proportional valve output calculated in the proportional valve output current calculation section 79 by use of the proportional valve pressure becomes the output of the control unit 12. Additionally, the attachment selection switch section 82 is switched to the solenoid valve ON-setting section 81 side. The solenoid directional control valve output adapted to ON-control the solenoid directional control valve 14 becomes the output of the control unit 12. If the solenoid directional control valve 14 is ON-controlled, the pilot line 14a is at a tank pressure. The directional control valve 15 is switched to the right position shown in the figure to allow the hydraulic lines 62a, 62b of the second actuator line 62 to communicate with each other. The attachment selection switch section 92 is switched to the solenoid valve ON-setting section 91 side, so that the solenoid directional control valve output adapted to ON-control the solenoid directional control valves 200, 201 becomes the output of the control unit 212. If the solenoid directional control valves 200, 201 are ON-controlled, the pilot lines 7a, 7b to which the operation pilot pressure of the control pedal device 7 is outputted are blocked. Thus, the tank pressure is led to the pressure-receiving portions 51a, 51b of the flow control valve B4.

(1-1) In the Case where the Operating Unit Corresponding to the Front Work Device 103 is Operated

If the operating units (not shown) of the actuators corresponding to the flow control valves B1 to B5 of the second valve group 5b are operated, the maximum pressure among their operation signals (the operation pilot pressures) is extracted by the shuttle valve group 21 and led to the capacity control system 9. The capacity control system 9 controls the capacity of the second hydraulic pump 3 on the basis of such a pilot pressure. In other words, the capacity of the second hydraulic pump 3 is controlled so that the amount of fluid necessary to be supplied to the corresponding actuators via the flow control valves B1 to B5 of the second valve group 5b is delivered. Thus, the bucket is mounded on the front work device 103 and excavating can be done.

(1-2) In the Case where the Control Pedal Device 7 Corresponding to the Attachment is Operated

If the control pedal 7c of the control pedal device 7 is operated, the operation pilot pressure is outputted to the pilot lines 7a, 7b. However, the operation pilot pressure is blocked by the solenoid directional control valves 200, 201, so that the flow control valve B4 is not switched from a neutral position. Therefore, even if work is intended to be performed by mounting the attachment (the breaker 110 in the present embodiment) on the front work device 103, since the hydraulic fluid is not supplied to the attachment, the work using the attachment cannot be done. The control is executed in which the pilot pressure to be outputted to the pilot line 7d is selected by the shuttle valve group 21 and supplied to the capacity control system 9 to increase the capacity of the second hydraulic pump 3. However, since the flow control valves B1 to B5 are not switched, the second hydraulic pump 3 is under no-load running.

(1-3) In the Case where the Operating Unit Corresponding to the Front Work Device 103 and the Control Pedal Device 7 Corresponding to the Attachment are Concurrently Operated

In this case, as with the above (1-1), if the operating units (not shown) of the actuators corresponding to the flow control valves B1 to B5 of the second valve group 5b are operated, the maximum pressure among their operation signals (the operation pilot pressures) is extracted by the shuttle valve group 21 and led to the capacity control system 9. The capacity control system 9 controls the capacity of the second hydraulic pump 3 on the basis of such a pilot pressure. In other words, the capacity of the second hydraulic pump 3 is controlled so that the amount of fluid necessary to be supplied to the corresponding actuators via the flow control valves B1 to B5 of the second valve group 5b is delivered. Thus, the bucket is mounded on the front work device 103 and excavating can be done. Additionally, as illustrated in the above (1-2), if the control pedal 7c of the control pedal device 7 is operated, the operation pilot pressure is outputted to the pilot lines 7a, 7b. However, the operation pilot pressure is blocked by the solenoid directional control valves 200, 201, so that the flow control valve B4 is not switched from a neutral position. Therefore, even if work is intended to be done by mounting the attachment (the breaker 110 in the present embodiment) on the front work device 103, since the hydraulic fluid is not supplied to the attachment, the work using the attachment cannot be done.

### (2) At the Time of Selecting the Attachment Mode

If the attachment selection device 20 selects the attachment mode (e.g. the ATT1 in which the breaker 110 is used as the attachment), the pump upper-limit flow selection switch section 72 is switched to the ATT1 pump upper-limit flow rate 71b. In addition, the operation mode selection switch section 77 is switched to the ATT mode side. Proportional valve pressure is calculated by the proportional valve pressure calculation section 78 by use of the pump upper-limit capacity selected by the maximum value selection section 75. The pump proportional valve output calculated by the proportional valve output current calculation section 79 by use of the proportional valve pressure becomes the output of the control unit 212. Additionally, the attachment selection switch section 82 is switched to the solenoid valve ON-setting section 81 side, so that the solenoid directional control valve output adapted to OFF-control the solenoid directional control valve 14 becomes the output of the control unit 212. If the solenoid directional control valve 14 is OFF-controlled, the pilot line 14a is at a delivery pressure of the pilot pump 4. In addition, the directional control valve 15 is switched to the left position shown in the figure so that the hydraulic line 62a of the second actuator line 62 communicates with the tank T. Additionally, the attachment selection switch section 92 is switched to the solenoid valve OFF-setting section 90 side, so that the solenoid directional control valve output adapted to OFF-control the solenoid directional control valves 200, 201 becomes the output of the control unit 212. If the solenoid directional control valves 200, 201 are OFF-controlled, the operation pilot pressure of the control pedal device 7 is led to the pressure-receiving portions 51a and 51b of the flow control valve B4 via the pilot lines 7a and 7b, respectively.

(2-1) In the Case where the Operating Unit Corresponding to the Front Work Device 103 is Operated

If the operating units (not shown) of the actuators corresponding to the flow control valves B1 to B5 of the second valve group 5b are operated, the maximum pressure among their operation signals (the operation pilot pressures) is extracted by the shuttle valve group 21 and led to the capacity control system 9. The capacity control system 9 controls the capacity of the second hydraulic pump 3 on the basis of such a pilot pressure. In other words, the capacity of the second hydraulic pump 3 is controlled so that the amount of fluid necessary to be supplied to the corresponding actuators via the flow control valves B1 to B5 of the second valve group 5b is delivered. Thus, the bucket is mounded on the front work device 103 and excavating can be done.

(2-2) In the Case where the Control Pedal Device 7 Corresponding to the Attachment is Operated

If the control pedal 7c of the control pedal device 7 is operated, its operation pilot pressure is led via the pilot line 7d to the shuttle valve 21b of the shuttle valve group 21. The maximum pressure among the operation pilot pressures including the operation signals from the other operating units is extracted by the shuttle valve group 21. In this case, the operation pilot pressure led from the shuttle valve group 21 to the capacity control system 9 is limited by the solenoid proportional valve 13 so as to provide the pump upper-limit flow rate corresponding to the attachment mode (ATT1) selected by the attachment selection device 20. In other words, the pump upper-limit capacity of the capacity of the second hydraulic pump 3 is controlled to a value suitable for ATT1. Thus, the attachment (the breaker 110 in the present embodiment) can be mounted on the front work device 103 and work can be done. In addition, the attachment is not used with its specifications exceeded so that it is possible to suppress the occurrence of the failure and reduced life of the attachment and of the other hydraulic devices.

(2-3) In the Case where the Operating Unit Corresponding to The Front Work Device 103 and the Control Pedal Device 7 Corresponding to the Attachment are Concurrently Operated

The operating units (not shown) of the actuators corresponding to the flow control valves B1 to B5 of the second valve group 5b and the control pedal 7c of the control pedal device 7 may concurrently be operated. In such a case, as described in the above (2-2), the operation pilot pressure led from the shuttle valve group 21 to the capacity control system 9 is limited by the solenoid proportional valve 13 so as to provide the pump upper-limit flow rate corresponding to the attachment mode (ATT1) selected by the attachment selection device 20. In short, the pump upper-limit capacity of the capacity of the second hydraulic pump 3 is controlled to a value suitable for ATT1. Thus, the attachment (the breaker 110 in the present embodiment) is mounted on the front work device 103 and work can be performed while operating the front work device 103. In addition, the attachment is not used with its specifications exceeded so that it is possible to suppress the occurrence of the failure and reduced life of the attachment and of the other hydraulic devices.

In the present embodiment configured as described above, in the state where the non-attachment mode is selected by the attachment selection device 20, the control pedal 7c of the control pedal device 7 may be operated. Even in such a case, the operation signal (the operation pilot pressure) transmitted from the control pedal device 7 to the attachment flow control valve B4 is blocked by the solenoid directional control valves 200, 201. In the case where the attachment is mounted on the front work device 103 and various works are to be performed, the attachment may be operated with the non-attachment mode remaining selected without setting corresponding to the type of the attachment. Even in such a case, therefore, the drive fluid is not supplied to the attachment via the flow control valve B4. Thus, it is possible to prevent the failure and reduced life of the attachment and of the other hydraulic devices in the event that an operator has forgotten to switch from the non-attachment mode to the attachment mode and has operated the attachment.

Additionally, it is possible to allow the operator to recognize that she or he has forgotten to switch from the non-attachment mode to the attachment mode. Prompting the operator to switch the operation mode to the attachment mode can further surely suppress the failure and reduced life of the attachment and of the other hydraulic devices.

### DESCRIPTION OF THE REFERENCE NUMERALS

1 Prime mover
2 First hydraulic pump
3 Second hydraulic pump
4 Pilot pump
5 Control valve unit
5a First valve group
5b Second valve group
7 Control pedal device (attachment operating means)
8, 9 Pump capacity control system
10, 11 Center bypass line
12, 212 Control unit
13 Solenoid valve
14 Solenoid directional control valve
15 Directional control valve
16 Pilot relief valve
17 Main relief valve
18, 19 Non-return valve (check valve)
20 Attachment selection device
21 Shuttle valve group
61 First actuator line
62 Second actuator line
63, 64 Relief valve
70 Pump upper-limit capacity first calculation section
71 Pump upper-limit flow setting section group
72 Pump upper-limit flow selection switch section
73 Target engine-speed setting section
74 Division section
75 Maximum value selection section
76, 276 Pump upper-limit capacity second calculation section
77 Operation mode selection switch section
78 Proportional valve pressure calculation section
79 Proportional valve output current calculation section
100 Lower travel structure
101 Upper swing structure
102 Swing post
103 Front work device
104 Blade
105 Engine room
106 Cabin
107 Swing motor
108 Boom
109 Arm
110 Breaker
111 Boom cylinder
112 Arm cylinder
113 Bucket cylinder
114a, 114b Traveling motor
A1 to A4, B1 to B5 Flow control valve

1. An attachment control apparatus for a hydraulic excavator having a hydraulic circuit that includes at least one hydraulic pump, a plurality of actuators having an attachment actuator, and a plurality of flow control valves having an attachment flow control valve that is switched by operation pilot pressure from attachment operating means to supply delivery fluid of the hydraulic pump to the attachment actuator, the attachment control apparatus comprising:
mode switching means for selecting either a non-attachment mode or an attachment mode and, upon selection of the attachment mode, switching a state of the hydraulic circuit to a state suitable for operating the attachment actuator; and
movement limiting means for limiting the movement of the attachment actuator when the attachment operating means is operated in a state where the attachment mode is not selected by the mode switching means.

2. The attachment control apparatus for the hydraulic excavator according to claim 1,
wherein the movement limiting means limits the flow rate of hydraulic fluid that is supplied to the attachment actuator, thereby limiting the movement of the attachment actuator.

3. The attachment control apparatus for the hydraulic excavator according to claim 2,
wherein the movement limiting means limits the delivery rate of the hydraulic pump, thereby limiting the flow rate of the hydraulic fluid that is supplied to the attachment actuator.

4. The attachment control apparatus for the hydraulic excavator according to claim 2,
wherein the movement limiting means limits the flow rate of hydraulic fluid passing through the attachment flow control valve, thereby limiting the flow rate of the hydraulic fluid that is supplied to the attachment actuator.
